(19) United States
(12) Patent Application Publication
(10) Pub. No.: US 2022/0250104 A1
(43) Pub. Date: Aug. 11, 2022

(54) DUAL PURPOSE LIQUID DISPENSER

(71) Applicant: W.C. BRADLEY CO., Columbus, GA (US)

(72) Inventors: GUNJIT KUMAR, NEWNAN, GA (US); THOMAS H. WARD, CATAULA, GA (US); SCOTT LAWRENCE WAYLAND, COLUMBUS, GA (US); ZACH MIRON, PHENIX CITY, AL (US); JOHN R. ALLEN, CATAULA, GA (US)

(21) Appl. No.: 17/667,193

(22) Filed: Feb. 8, 2022

Related U.S. Application Data
(60) Provisional application No. 63/147,208, filed on Feb. 8, 2021.

(51) Int. Cl. B05B 11/00; B05B 1/12; A23P 20/18; A23P 20/25; B65D 25/56

(52) U.S. Cl. CPC B05B 11/0008; B05B 11/0037; B05B 1/12; B65D 2203/04; A23P 20/25; B65D 25/56; A23P 20/18

(57) ABSTRACT

A multi-mode flavorant dispenser includes a common pump and reservoir, a first detachable nozzle selectively fitted to the common pump to dispense fluid from the reservoir in a spray pattern, and a second detachable nozzle selectively fitted to the common pump to dispense fluid from the reservoir by a needle injector.

### CROSS-REFERENCE TO RELATED CASES

This application claims the benefit of U.S. provisional patent application Ser. No. 63/147,208, filed on Feb. 8, 2021, and incorporates such provisional application by reference into this disclosure as if fully set out at this point.

### FIELD OF THE INVENTION

This disclosure relates to cooking in general and, more particularly, to application of flavorings to food before or during cooking.

### BACKGROUND OF THE INVENTION

As a part of the preparation and cooking process, particularly for meat cooked for longer times and lower temperatures, liquid flavorants such as mixtures of fruit juice and water may be utilized. These may be added to the food in different ways, such as spraying the surface of the food. Spray application wets the outside surfaces and affects the taste and appearance of the of the outer layer of food being cooked. Another way of using flavorants is to inject the liquid into the interior of the food, which affects the taste and appearance of the interior. Flavorants may need to be prepared multiple times to utilize multiple application methods. Multiple applicators may also be required.

What is needed is a system and method for addressing the above and related issues.

### SUMMARY OF THE INVENTION

The invention of the present disclosure, in one aspect thereof, comprises a multi-mode flavorant dispenser including a common pump and reservoir, a first detachable nozzle selectively fitted to the common pump to dispense fluid from the reservoir in a spray pattern, and a second detachable nozzle selectively fitted to the common pump to dispense fluid from the reservoir by a needle injector.

The first detachable nozzle may be adjustable to provide a plurality of spray patterns. The second detachable nozzle may include comprises a length of tubing between the common pump and the needle injector.

In some cases, the reservoir comprises at least a translucent portion and graduations applied proximate thereto indicated a volume of the fluid in the reservoir. The multi-mode flavorant dispenser may further comprising a shell surrounding the reservoir. The shell may provide a cutout for viewing the reservoir. It may provide a threaded cap on a bottom thereof, opposite the common pump proximate a top thereof, that is removable for insertion or removal of the reservoir. The common pump may attach to the shell with a tube extending into the reservoir to withdraw fluid therefrom.

Some embodiments include a storage mechanism on an outside of the reservoir configured to selectively receive and retain one of the first detachable nozzle or the second detachable nozzle. The storage mechanism may comprise a loop spaced apart from a receptacle, the loop being sized to receive the second detachable nozzle such that the needle injector is received in the receptacle. The receptacle may be sized to receive the first detachable nozzle. A loop may be provided on an outside of the reservoir with an attached carabiner.

In invention of the present disclosure, in another aspect thereof, comprises a multi-mode liquid flavorant dispensing kit. The kit includes a liquid flavorant reservoir, a plurality of nozzles, and a pump having a tube extending into the reservoir and being operable to withdraw the liquid flavorant when actuated and to propel the same through one of the plurality of nozzles when the one of the plurality of nozzles is attached to the pump.

In some embodiments, the plurality of nozzles includes at least one spray nozzle and at least one injection nozzle. The injection nozzle may comprise a hose affixed to an injection needle.

In some cases, the kit includes a shell containing the reservoir. The pump may be affixed to the shell, with the shell opening to allow removal of the reservoir.

The invention of the present disclosure, in another aspect thereof, comprises a flavorant dispensing device including a reservoir that is at least partially translucent and receives liquid flavorant, a pump that is actuated to propel liquid flavorant from the reservoir out through a detachable nozzle, and a set of detachable nozzles that may be individually selectively attached to the pump by a user, the set of nozzles including at least one spray nozzle and at least one injection nozzle.

The flavorant dispensing device may further comprise a shell surrounding the reservoir and affixed to the pump. The shell may be graduated and provide an opening for viewing of the reservoir to indicate a level of liquid flavorant in the reservoir.

### BRIEF DESCRIPTION OF THE DRAWINGS

FIG. 1 is a side, partial cutaway view of a liquid flavorant applicator according to aspects of the present disclosure.

FIG. 2 is a side, partial cutaway view of the applicator of FIG. 1 with an injection attachment.

FIG. 3 is a side, partial cutaway view of another liquid flavorant applicator according to aspects of the present disclosure.

FIG. 4 is a s side, partial cutaway view of the applicator of FIG. 3 with an injection attachment.

FIG. 5A is a side view of another liquid flavorant applicator according to aspects of the present disclosure.

FIG. 5B is a perspective view of an interior reservoir for use with the flavorant applicator of FIG. 5A.

FIG. 6s is a side view of a liquid flavorant applicator according to aspects of the present disclosure.

FIG. 7 is a side cutaway view of the liquid flavorant applicator of FIG. 6.

FIG. 8 us another side cutaway view of the liquid flavorant applicator of FIG. 7.

### DETAILED DESCRIPTION OF THE PREFERRED EMBODIMENTS

The use of separate mechanical devices to carry out spraying and injection of flavorants functions is cumbersome and previously required the storage of two devices in or around the cooking appliance. This was also and expensive due to the duplication of functionality in the storage and pump mechanisms of the two devices.

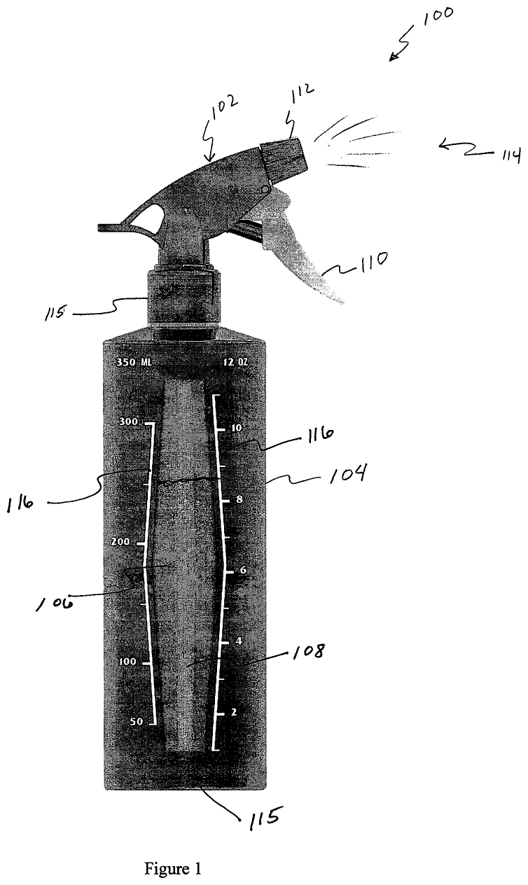

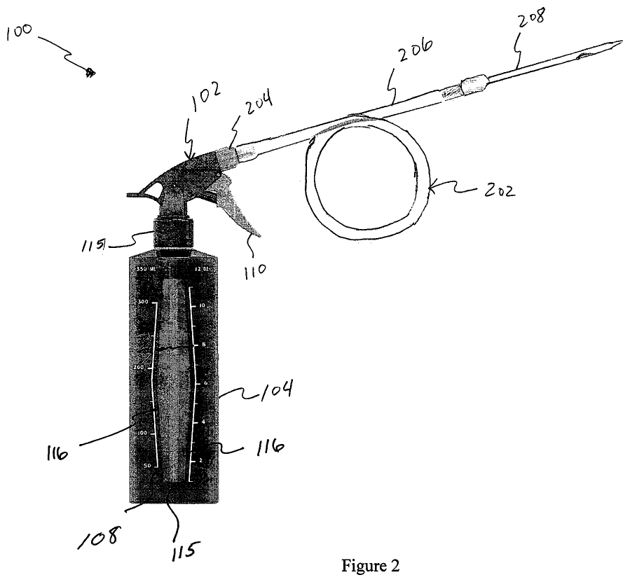

With reference to FIGS. 1-2, liquid flavorant applicators of the present disclosure (such as applicator 100) utilize a single storage chamber or reservoir 104 along with a single pump mechanism 102 or sprayer head attached to the reservoir 104. Two or more separate nozzles 112, 202 with a common attachment interface (such as a threaded attached with the pump 102) may be utilized. A spray nozzle 112 may be configured to attach to the pump 102 and dispenses a variable spray 114 from the nozzle 112 using well known spray pump technology involving the actuation of a mechanical lever 110 operating the pump 102. A second injector nozzle 202 may selectively replace the spray nozzle 112.

The injector nozzle 202 may comprise an injector needle 208 connected by flexible tubing 206 to a fitting 204 selectively attaching to the pump 102. The injector needle 208 may be inserted into the food such that operation of the mechanical lever 110 connected to the pump 102 forces liquid through the tubing 206 and out the needle 208. The pump 102 may be removably fitted (e.g., by a threading engagement) to the reservoir 104 which contains the flavorant 106. The pump 102 may comprise a straw or tube 108 used to draw the liquid flavorant into the pump 102 as is known in the art.

By having a single reservoir 104 and lever operated pump 102, but alternate nozzles 112, 202, a single device 100 can fulfill the functions of two or more previous devices. The same flavorant 106 can be used for spraying the surface as well as infusing the interior of the food, as is commonly done at different times in the cooking cycle. On the other hand, if only one of the operations (spraying or infusing) is required, the device 100 can remain in a single configuration during the course of cooking such a particular item. By having only a single device 100 there is substantial cost savings to the user, as well as less clutter by having fewer devices to organize and store before, during, and after the cooking experience.

The pump 102 may have a threaded fitting 115 for attachment to a threaded neck on the reservoir 104. The reservoir 104 may comprise a polymer bottle, a metallic bottle, or another suitable container. In some embodiments, a clear or translucent window 115 into the reservoir 104 may allow for viewing a level of flavorant 106 remaining in the storage chamber. Graduations or level markings 116 may be provided near or on the window 115 may provide an indication of the specific volume of flavorant 106 remaining. The graduations 116 may be in imperial or metric units or another measurement system.

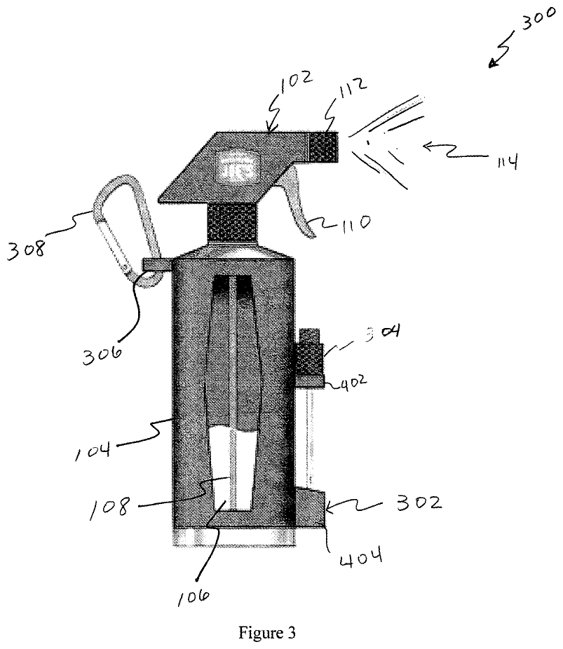

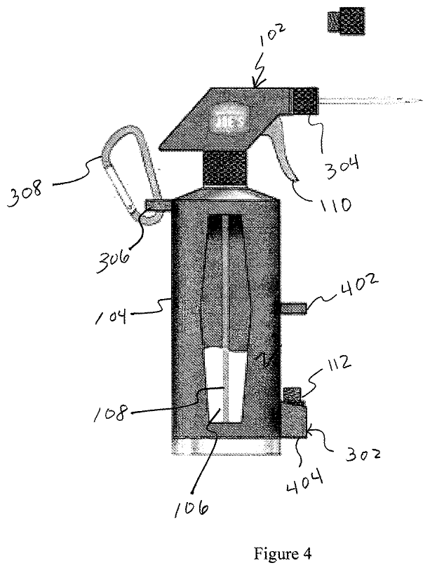

With reference now to FIGS. 3-4 another embodiment of a multi-purpose liquid flavorant dispenser 300 is shown. The same or a similar pump mechanism 102 and reservoir 104 as the device 200 may be used here. The nozzle 112 operates with a spray pattern 114, as described. A different injector nozzle 304 is used here, that does not have a tubing. Instead, the nozzle 304 comprises an injector needle that attaches via a fitting directly to the pump mechanism 102. With the device 300, a user may inject flavorant 106 directly into a food item while gripping the device 300 only by the pump mechanism 300. One of skill in the art will appreciate relative advantages of each type of injector (202, 304).

The device 300 also provides a storage mechanism 302 that can retain both types of nozzles (112, 304) or others. The storage mechanism 302 may comprise an upper loop 402 and lower receptacle 404. As shown in FIG. 3, the injector nozzle 304 may be placed through the loop 402 with a sharp tip thereof retain in the receptacle 404. As shown in FIG. 4, the spray nozzle 112 may be sized to fit into the receptacle 404. Thus, the storage mechanism 302 may conveniently retain the non-used nozzle at all times.

The dispenser 300 may also have additional convenience features. As shown, a loop 306 may be integrated with the reservoir 104 or other component to allow a carabiner 308 or other attachment or hanging device to be affixed to the dispenser 300.

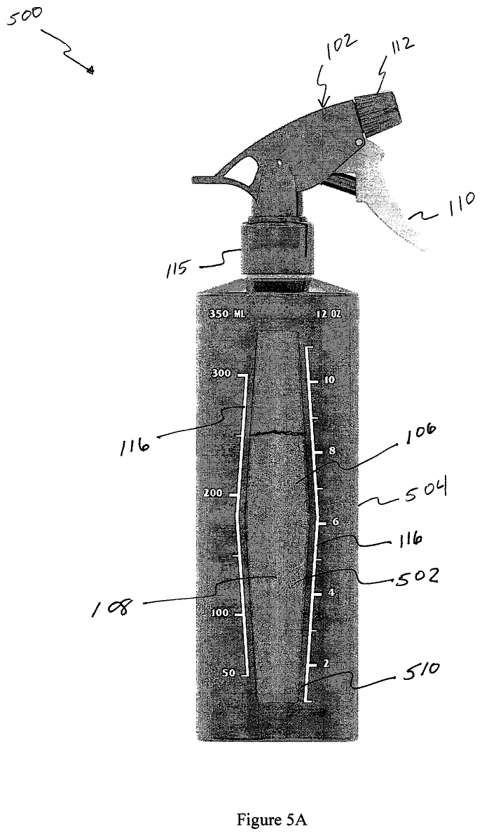

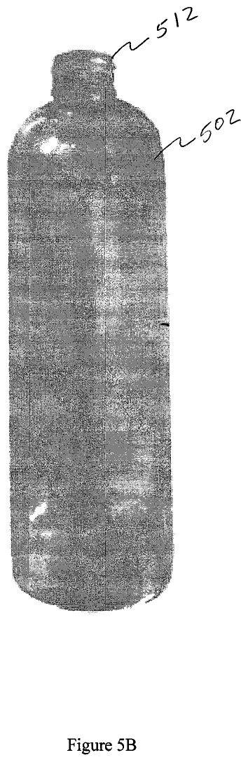

Referring now to FIG. 5A, a side view of another liquid flavorant applicator 500 according to aspects of the present disclosure is shown. The flavor applicator 500 of FIG. 5A utilizes the pump 102 similar to previous embodiments. It may be utilized with various nozzles such a spray nozzle 112 as shown, with injector nozzle 202, or others.

An internal 502 reservoir is utilized (shown in FIG. 5B in perspective) that is stored or secured within a shell 504. The reservoir 502 may comprise a polymer or plastic bottle. The reservoir 502 may be replaceable or refillable, and may be removable from the shell 504 as discussed further below. The shell may have an internal threaded fitting to receive a threaded neck 512 of the bottle 502. The pump 102 may thread onto the shell or otherwise be affixed on a top of the shell 504 such that the tube 108 extends into the reservoir 502 when the flavor applicator 500 is assembled. The shell 504 provides graduations 116 that indicate volume of flavorant 106 remaining in the reservoir 502. The shell 504 itself may have a metallic or polymer construction, and may provide a rigid construction.

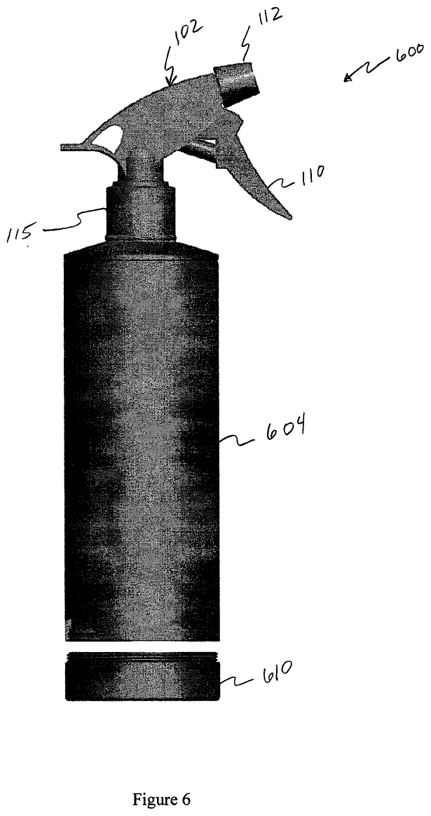

Referring now to FIG. 6, a side view of a liquid flavorant applicator 600 according to aspects of the present disclosure is shown. The applicator 600 utilizes the pump 102 but has a shell 604 that may be of a solid and/or opaque construction. In other embodiments, windows, clear portions, and/or graduations may be provided to allow viewing of internal contents. The shell 604 may be configured to receive an internal reservoir (e.g., reservoir 502). The shell 604 may have a lower cap 610 that threads onto or off the shell 604 to allow for refilling or replacement of the internal reservoir.

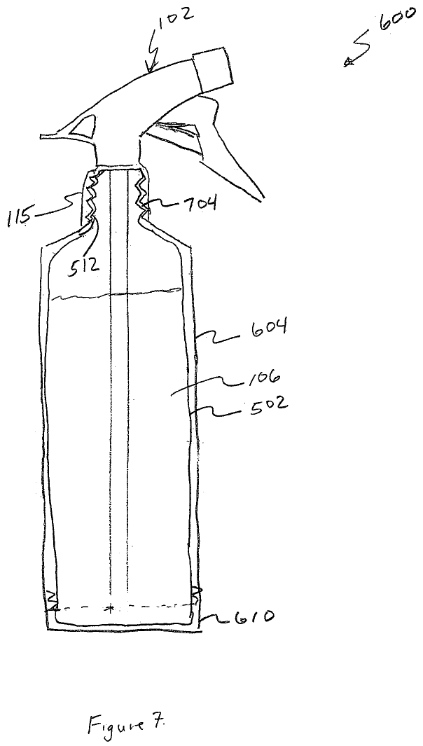

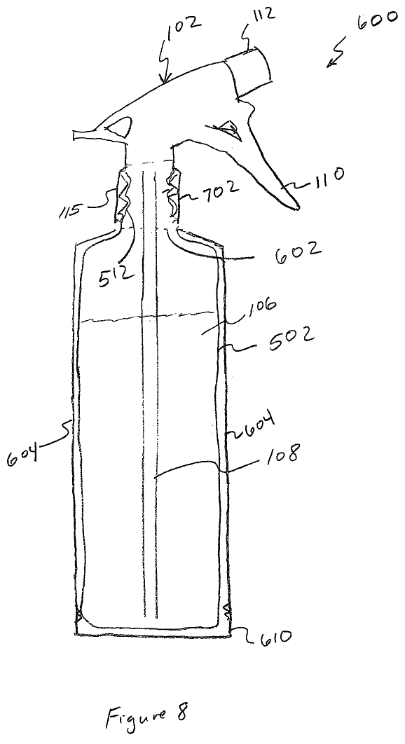

Referring now to FIG. 7, it can be seen that the neck 512 of the reservoir 502 may fit into internal threads in a neck 704 of the shell 604. In such case, the pump 102 may also thread directly to the neck 704 of the reservoir shell 604. The fitting between the pump 102 and reservoir 604 could also be a permanent connection. FIG. 8 illustrates that, in some embodiments, the shell 604 may form an opening 602 on a top thereof that allows the neck 512 of the reservoir 502 to thread directly into the fitting 115 of the pump 102. It should also be understood that the flavorant applicator 500 of FIG. 5 may be configured for assembly according to the embodiments illustrated in FIGS. 7-8.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A multi-mode flavorant dispenser comprising:
a common pump and reservoir;
a first detachable nozzle selectively fitted to the common pump to dispense fluid from the reservoir in a spray pattern; and
a second detachable nozzle selectively fitted to the common pump to dispense fluid from the reservoir by a needle injector.

2. The multi-mode flavorant dispenser of claim 1, wherein the first detachable nozzle is adjustable to provide a plurality of spray patterns.

3. The multi-mode flavorant dispenser of claim 1, wherein the second detachable nozzle comprises a length of tubing between the common pump and a needle injector.

4. The multi-mode flavorant dispenser of claim 1, wherein the reservoir comprises at least a translucent portion and graduations applied proximate thereto indicated a volume of the fluid in the reservoir.

5. The multi-mode flavorant dispenser of claim 1, further comprising a shell surrounding the reservoir.

6. The multi-mode flavorant dispenser of claim 5, wherein the shell provides a cutout for viewing the reservoir.

7. The multi-mode flavorant dispenser of claim 5, wherein the shell provides a threaded cap on a bottom thereof, opposite the common pump proximate a top thereof, that is removable for insertion or removal of the reservoir.

8. The multi-mode flavorant dispenser of claim 7, wherein the common pump attaches to the shell with a tube extending into the reservoir to withdraw fluid therefrom.

9. The multi-mode flavorant dispenser of claim 1, further comprising a storage mechanism on an outside of the reservoir configured to selectively receive and retain one of the first detachable nozzle or the second detachable nozzle.

10. The multi-mode flavorant dispenser of claim 9, wherein the storage mechanism comprises a loop spaced apart from a receptacle, the loop being sized to receive the second detachable nozzle such that the needle injector is received in the receptacle.

11. The multi-mode flavor injector of claim 10, wherein the receptacle is sized to receive the first detachable nozzle.

12. The multi-mode flavorant dispenser of claim 1, further comprising a loop on an outside of the reservoir with an attached carabiner.

13. A multi-mode liquid flavorant dispensing kit:
a liquid flavorant reservoir;
a plurality of nozzles; and
a pump having a tube extending into the reservoir and being operable to withdraw the liquid flavorant when actuated and to propel the same through one of the plurality of nozzles when the one of the plurality of nozzles is attached to the pump.

14. The multi-mode flavorant dispensing kit of claim 1, wherein the plurality of nozzles includes at least one spray nozzle and at least one injection nozzle.

15. The multi-mode flavorant dispensing kit of claim 14, wherein the injection nozzle comprises a hose affixed to an injection needle.

16. The multi-mode flavorant dispensing kit of claim 1, further comprising a shell containing the reservoir.

17. The multi-mode flavorant dispensing kit of claim 16, wherein the pump is affixed to the shell and the shell opens to allow removal of the reservoir.

18. A flavorant dispensing device comprising:
a reservoir that is at least partially translucent and receives liquid flavorant;
a pump that is actuated to propel liquid flavorant from the reservoir out through a detachable nozzle;
a set of detachable nozzles that may be individually selectively attached to the pump by a user, the set of nozzles including at least one spray nozzle and at least one injection nozzle.

19. The flavorant dispensing device of claim 18, further comprising a shell surround the reservoir and affixed to the pump.

20. The flavorant dispending device of claim 19, wherein the shell is graduated and provides an opening for viewing of the reservoir to indicate a level of liquid flavorant in the reservoir.
